(19) United States
(12) Patent Application Publication
(10) Pub. No.: US 2012/0084585 A1
(43) Pub. Date: Apr. 5, 2012

(54) INFORMATION PROCESSING APPARATUS CAPABLE OF REMOTE POWER CONTROL, POWER CONTROL METHOD THEREFOR, AND STORAGE MEDIUM

(75) Inventor: Junnosuke Yokoyama, Tokyo (JP)

(73) Assignee: CANON KABUSHIKI KAISHA, Tokyo (JP)

(21) Appl. No.: 13/245,943

(22) Filed: Sep. 27, 2011

(30) Foreign Application Priority Data
Sep. 30, 2010 (JP) 2010-221786

(51) Int. Cl. G06F 1/32

(52) U.S. Cl. 713/320

(57) ABSTRACT

An information processing apparatus that has a plurality of functional units and is capable of communicating with a power monitoring apparatus and supplying power to an appropriate functional unit according to whether a main power switch is operated by an operator or a power-on instruction is received from the power monitoring apparatus. Power that should be supplied to the plurality of functional units is generated. When the main power switch is manually operated by the operator in a state where the generated power is not supplied to the plurality of functional units, control is performed to supply the generated power to the plurality of functional units. In response to the power-on instruction received in a state where the generated power is not supplied to the plurality of functional units, control is provided to supply the generated power to functional units designated in advance among the plurality of functional units.

### BACKGROUND OF THE INVENTION

1. Field of the Invention

The present invention relates to an information processing apparatus, a power control method therefor, and a computer-readable storage medium storing a power control program, and more particularly to remote power control for an information processing apparatus.

2. Description of the Related Art

In general, when power to an information processing apparatus is controlled, power may be remotely controlled (remote power control). For example, power to a plurality of information processing apparatuses connected to a network may be controlled (power-off and power-on) based on instructions from a power monitoring apparatus such as a host computer.

A description will now be given of a case where remote power control is performed for an image forming apparatus which is an example of information processing apparatuses. The image forming apparatus generally consumes a large amount of power, and in a system where a plurality of image forming apparatuses are connected to a network, large current flows due to inrush current at start-up if the plurality of image forming apparatuses are powered on at the same time.

To cope with this problem, there have been techniques that a plurality of image forming apparatuses are powered on one by one by assigning priority so as to prevent the plurality of image forming apparatuses from being powered on at the same time. For example, a power monitoring apparatus sends a power-on instruction to an image forming apparatus given the highest priority. Then, after the image forming apparatus given the highest priority is powered on, the powered-on image forming apparatus sends a power-on instruction to an image forming apparatus given the second highest priority (see, for example, Japanese Laid-Open Patent Publication (Kokai) No. 2000-238373).

However, according to the technique described in Japanese Laid-Open Patent Publication (Kokai) No. 2000-238373, as the number of image forming apparatuses connected to a network increases, the time that elapses before an image forming apparatus given the lowest priority is powered on increases. Further, when there is an image forming apparatus which cannot be powered on due to a failure or the like, the problem that image forming apparatuses given lower priorities are not powered on arises.

### SUMMARY OF THE INVENTION

The present invention provides an information processing apparatus that has a plurality of functional units and is capable of communicating with a power monitoring apparatus and supplying power to an appropriate functional unit according to whether a main power switch is operated by an operator of the information processing apparatus or a power-on instruction is received from the power monitoring apparatus, a power control method therefor, and a computer-readable storage medium storing a power control program.

Accordingly, a first aspect of the present invention provides an information processing apparatus capable of communicating with a power monitoring apparatus via a network, comprising a power generation unit configured to generate power that should be supplied to a plurality of functional units which the information processing apparatus has, a main power supply switch configured to be manually operated, a receiving unit configured to receive a power-on instruction from the power monitoring apparatus via the network, a first power control unit configured to, in response to the main power switch being manually operated by an operator of the information processing apparatus in a state where the power generated by the power generation unit is not supplied to the plurality of functional units, provide control to supply the power generated by the power generation unit to the plurality of functional units, and a second power control unit configured to, in response to the receiving unit receiving the power-on instruction from the power monitoring apparatus via the network in a state where the power generated by the power generation unit is not supplied to the plurality of functional units, provide control to supply the power generated by the power generation unit to functional units designated in advance among the plurality of functional units.

Accordingly, a second aspect of the present invention provides a power control method for remotely controlling power to an information processing apparatus having a plurality of functional units to which power is supplied independently of each other, and a main power switch that is manually operated, and capable of communicating with a power monitoring apparatus via a network, comprising a power generation step of generating power that should be supplied to the plurality of functional units which the information processing apparatus has, a receiving step of receiving a power-on instruction from the power monitoring apparatus via the network, a first power control step of, in response to the main power switch being manually operated by an operator of the information processing apparatus in a state where the power generated in the power generation step is not supplied to the plurality of functional units, providing control to supply the power generated in the power generation step to the plurality of functional units, and a second power control step of, in response to receipt of the power-on instruction from the power monitoring apparatus via the network in the receiving step in a state where the power generated in the power generation step is not supplied to the plurality of functional units, providing control to supply the power generated in the power generation step to functional units designated in advance among the plurality of functional units.

Accordingly, a third aspect of the present invention provides a computer-readable non-transitory storage medium storing a power control program that implements a power control method for remotely controlling power to an information processing apparatus having a plurality of functional units to which power is supplied independently of each other, and a main power switch that is manually operated, and capable of communicating with a power monitoring apparatus via a network, the method comprising a power generation step of generating power that should be supplied to the plurality of functional units which the information processing apparatus has, a receiving step of receiving a power-on instruction from the power monitoring apparatus via the network, a first power control step of, in response to the main power switch being manually operated by an operator of the information processing apparatus in a state where the power generated in the power generation step is not supplied to the plurality of functional units, providing control to supply the power generated in the power generation step to the plurality of functional units, and a second power control step of, in response to receipt of the power-on instruction from the power monitoring apparatus via the network in the receiving step in a state where the power generated in the power generation step is not supplied to the plurality of functional units, providing control to supply the power generated in the power generation step to functional units designated in advance among the plurality of functional units.

According to the present invention, in the information processing apparatus that has the plurality of functional units and is capable of communicating with the power monitoring apparatus, power can be supplied to an appropriate functional unit according to whether a main power switch is operated by an operator of the information processing apparatus or a power-on instruction is received from the power monitoring apparatus.

Further features of the present invention will become apparent from the following description of exemplary embodiments (with reference to the attached drawings).

### BRIEF DESCRIPTION OF THE DRAWINGS

FIG. 1 is a diagram showing an exemplary print system using one of information processing apparatuses according to an embodiment of the present invention.

FIG. 2 is a flowchart useful in explaining a remote command issuance process carried out by a host computer appearing in FIG. 1.

FIGS. 3A and 3B are block diagrams useful in schematically explaining power supply lines in respective image forming apparatuses appearing in FIG. 1.

FIG. 4 is a diagram showing an internal arrangement of a main SW with relay appearing in FIG. 3B.

FIG. 5 is a flowchart useful in explaining a process carried out by an input-output control unit when power is supplied to a main power supply unit appearing in FIG. 3B.

FIG. 6 is a diagram showing an exemplary remote power control setting screen (local screen) displayed when a power supply unit that supplies power is added or changed in an image forming apparatus appearing in FIGS. 3A and 3B.

FIG. 7 is a diagram showing power control settings according to functions selected in effective function settings right after power-on appearing in FIG. 6.

### DESCRIPTION OF THE EMBODIMENTS

A description will now be given of an exemplary information processing apparatus according to an embodiment of the present invention. It should be noted that in the following description, an image forming apparatus is taken as example of information processing apparatus, but for information processing apparatuses other than image forming apparatuses, power can be controlled in the same manner. A system in which image forming apparatuses which are examples of information processing apparatuses are connected to each other via a network is called a printing system.

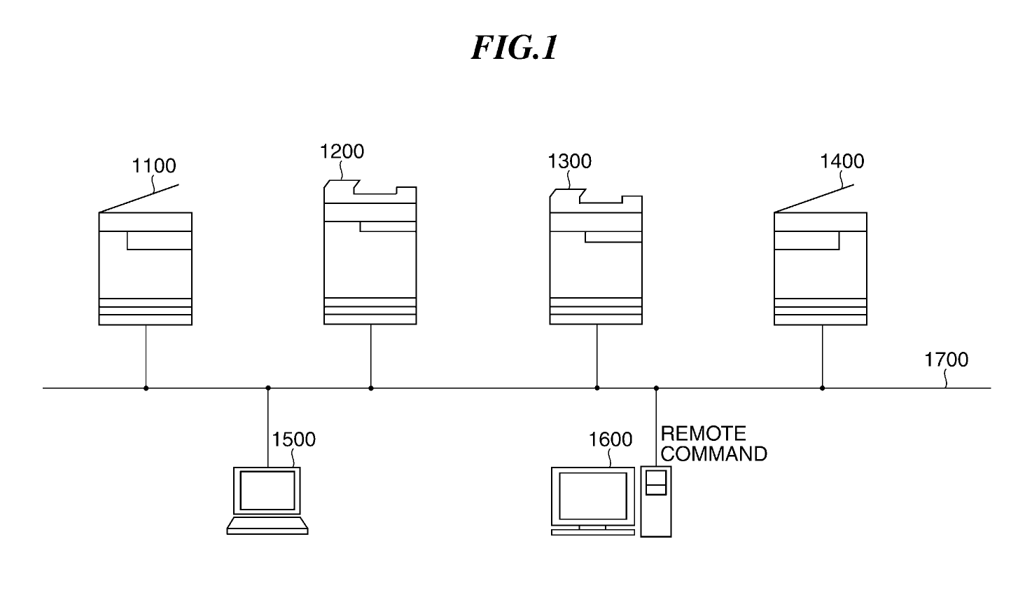

FIG. 1 is a diagram showing an exemplary printing system using image forming apparatuses which are examples of information processing apparatuses (for example, multifunctional peripherals) according to the embodiment of the present invention.

Referring to FIG. 1, the printing system has a plurality of multifunctional peripherals 1100, 1200, 1300, and 1400. The multifunctional peripherals 1100, 1200, 1300, and 1400 are connected to a network 1700. A host computer 1600 (power monitoring apparatus) is connected to the network 1700. With this arrangement, the multifunctional peripherals 1100, 1200, 1300, and 1400 can communicate with the host computer 1600 via the network 1700.

In the example showing in the figure, a personal computer (PC) 1500 is connected to the network 1700. In the network system shown in the figure, the host computer 1600 monitors power supply to multifunctional peripherals 1100, 1200, 1300, and 1400. Main power to the multifunctional peripherals 1100, 1200, 1300, and 1400 is turned on and off according to remote commands sent from the host computer 1600.

Upon receiving a remote command indicative of power-off (off-command: command to turn off power) from the host computer 1600, each of the multifunctional peripherals 1100, 1200, 1300, and 1400 terminates an operation in progress. Each of the multifunctional peripherals 1100, 1200, 1300, and 1400 then saves data in process to a backup memory (not shown).

When the multifunctional peripherals 1100, 1200, 1300, and 1400 are placed in a state of readiness to be powered-off as a result of data saving as described above, main power to the multifunctional peripherals 1100, 1200, 1300, and 1400 is turned off. After turning off of main power, each of the multifunctional peripherals 1100, 1200, 1300, and 1400 does not accept a network command indicative of access request from a PC 1500, and only responds to a remote command indicative of power-on (on command: command to supply power) issued from the host computer 1600.

As described above, there are at least two types of remote commands indicative of power-off and power-on (an off-command and an on-command). These remote commands are issued in unison from the host computer 1600 to all the multifunctional peripherals 1100, 1200, 1300, and 1400 on the network 1700.

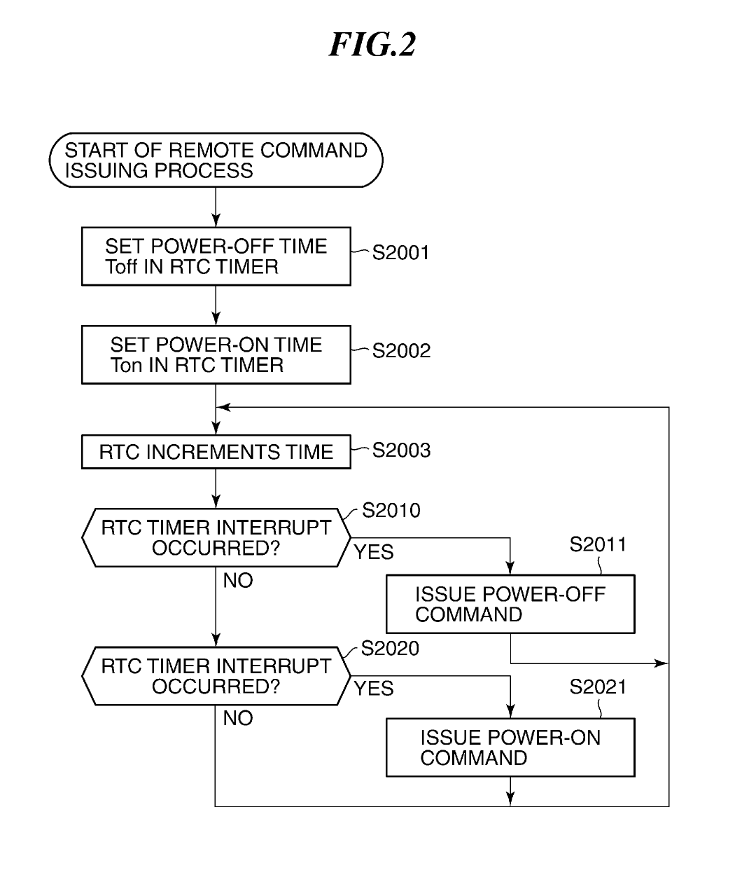

FIG. 2 is a flowchart useful in explaining a remote command issuance process carried out by the host computer 1600 appearing in FIG. 1.

Referring to FIGS. 1 and 2, a power-off time Toff and a power-on time Ton are set in the host computer 1600. The host computer 1600 counts (measures) time using a real-time clock (RTC: not shown). When the count value (that is, time) of the RTC reaches the power-off time Toff or the power-on time (power supply time) Ton, RTC timers (not shown) in the host computer 1600 generate an interrupt signal.

First, the host computer 1600 sets the power-off time Toff (for example, 21:30) in the first RTC timer (step S2001), and sets the power-on time Ton (for example, 8:00) in the second RTC timer (step S2002).

In the host computer 1600, the RTC increments time (step S2003). The host computer 1600 checks whether or not the first RTC timer has generated an interrupt signal (step S2010). When the time counted by the RTC reaches the power-off time Toff, the first RTC timer outputs an interrupt signal (first interrupt signal).

When the first RTC timer has generated the first interrupt signal (YES in the step S2010), the host computer 1600 issues an off-command to all the multifunctional peripherals 1100, 1200, 1300, and 1400 in unison (step S2011). Then, the host computer 1600 returns to the step S2003 to continuously carry out the process.

On the other hand, when the first RTC timer has not generated the first interrupt signal (NO in the step S2010), the host computer 1600 determines whether or not the second RTC timer has generated an interrupt signal (second interrupt signal) (step S2020).

Now, when the time counted by the RTC reaches the power-on time Ton, the second RTC timer outputs the second interrupt signal. When the second interrupt signal has been generated from the second RTC timer (YES in the step S2020), the host computer 1600 issues an off-command to all the multifunctional peripherals 1100, 1200, 1300, and 1400 in unison (step S2021). Then, the host computer 1600 returns to the step S2003 to continuously carry out the process.

On the other hand, when the second RTC timer has not generated the second interrupt signal (NO in the step S2020), the host computer 1600 returns to the step S2003 to continuously carry out the process. Upon receiving a remote command (an off-command or an on-command), each of the multifunctional peripherals 1100, 1200, 1300, and 1400 on the network 1700 carries out a power-off or power-on process.

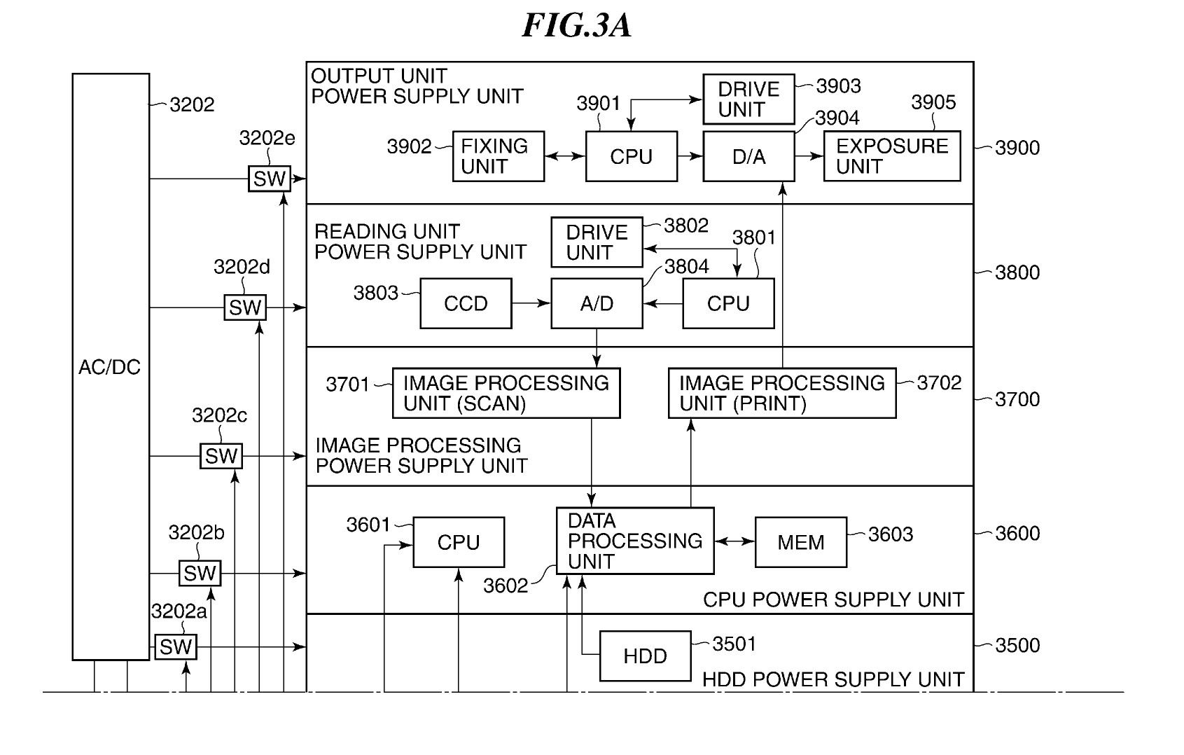

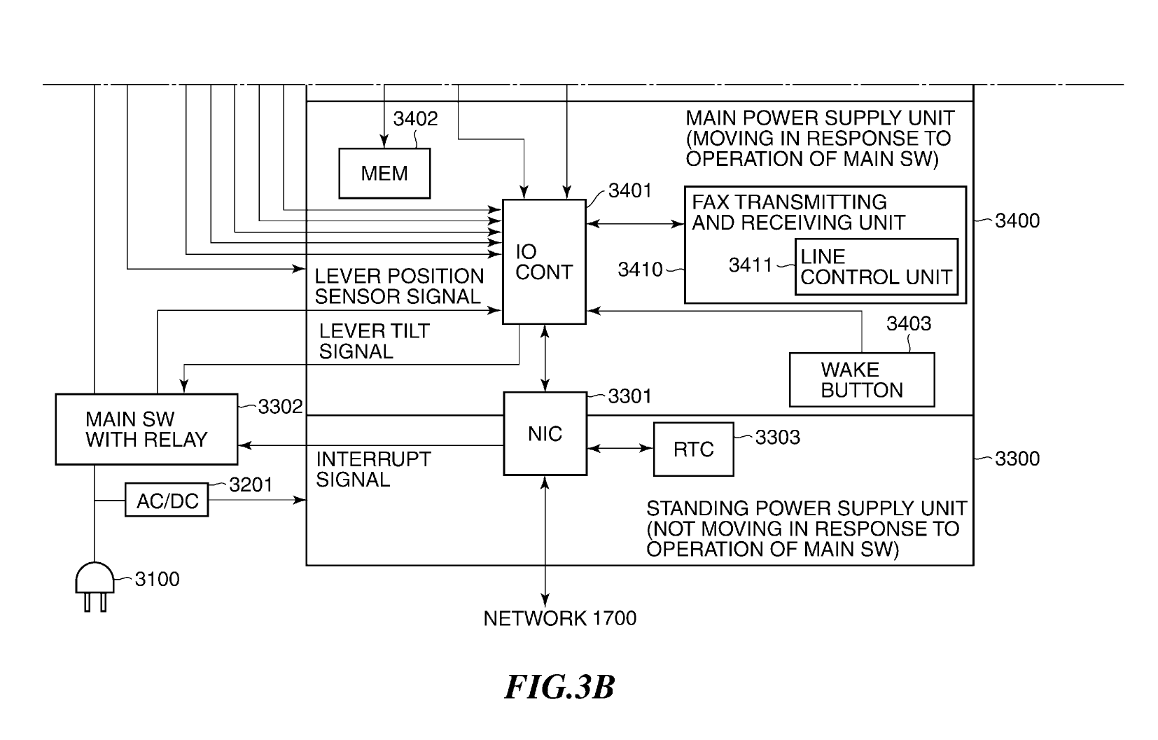

FIGS. 3A and 3B are block diagrams useful in schematically explaining power supply lines in the multifunctional peripherals 1100, 1200, 1300, and 1400 appearing in FIG. 1.

Referring to FIGS. 3A and 3B, the multifunctional peripherals 1100, 1200, 1300, and 1400 have the same power supply line, and hence the following description will be given with attention focused on the multifunctional peripheral 1100.

The multifunctional peripheral 1100 has a standing power supply unit 3300 (first functional unit), a main power supply unit 3400, an HDD power supply unit 3500, a CPU power supply unit 3600, an image processing power supply unit 3700, a reading unit power supply unit 3800, and an output unit power supply unit 3900 (they are functional units). The standing power supply unit 3300 has a NIC (network interface card) unit 3301 and an RTC 3303.

The standing power supply unit 3300, the main power supply unit 3400, the HDD power supply unit 3500, the CPU power supply unit 3600, the image processing power supply unit 3700, the reading unit power supply unit 3800, and the output unit power supply unit 3900 are supplied with power independently of each other.

The main power supply unit 3400 has an input-output control unit (IO Cont) 3401, a memory (Mem) 3402, a wake button 3403, and a FAX transmitting and receiving unit 3410. It should be noted that the FAX transmitting and receiving unit 3410 has a line control unit 3411.

The HDD power supply unit 3500 has an HDD 3501, and the CPU power supply unit 3600 has a CPU 3601, a data processing unit 3602, and a memory (Mem) 3603. The image processing power supply unit 3700 has an image processing unit (Scan) 3701 and an image processing unit (print) 3702.

The reading unit power supply unit 3800 has a CPU 3801, a drive unit 3802, a CCD 3803, and an A/D converter 3804, and the output unit power supply unit 3900 has a CPU 3901, a fixing unit 3902, a drive unit 3903, a D/A converter 3904, and an exposure unit 3905.

The multifunctional peripherals 1100 is supplied with AC power from an AC power source 3100. The AC power is then converted into DC power by an AC/DC converter 3201 and an AC/DC converter 3202. With the AC power source 3100 connected to the multifunctional peripherals 1100, the DC power is supplied from the AC/DC converter 3201 to only the standing power supply unit 3300, and as a result, the DC power is supplied to part of the NIC unit 3301.

The NIC unit 3301 has at least two lines of power supply, and when power is supplied to only one line, the NIC unit 3301 responds to specific remote commands on the network 1700. The specific remote commands include an on-command describe above, and upon receiving the on-command, the NIC unit 3301 sends out an interrupt signal (also referred to as an on-interrupt signal) to a main switch (SW) with relay 3302.

Upon receiving the on-interrupt signal, the main SW with relay 3302 (main power switch) turns its internal relay on. As a result, AC power is supplied from the AC power source 3100 to the AC/DC converter 3202, and DC power is supplied from the AC/DC converter 3202 to the main power supply unit 3400.

As shown in the figure, the HDD power supply unit 3500, the CPU power supply unit 3600, the image processing power supply unit 3700, the reading unit power supply unit 3800, and the output unit power supply unit 3900 are connected to the AC/DC converter 3202 via respective switches (SWs) 3202a to 3202e. As will be described later, the IO Cont 3401 turns on and off the SWs 3202a to 3202e so that power can be supplied to the HDD power supply unit 3500, the CPU power supply unit 3600, the image processing power supply unit 3700, the reading unit power supply unit 3800, and the output unit power supply unit 3900.

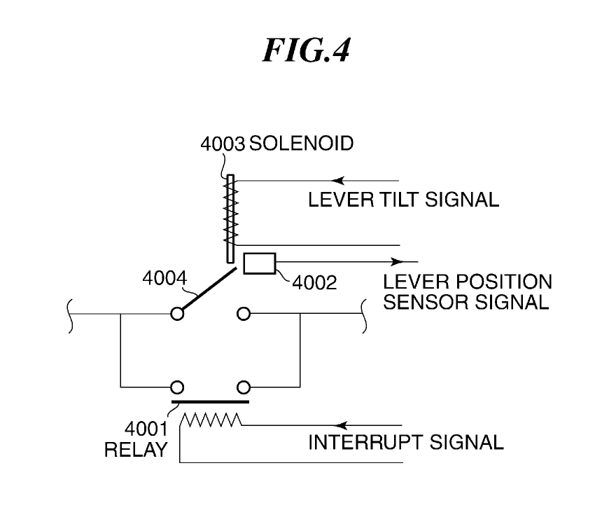

FIG. 4 is a diagram showing an exemplary internal arrangement of the main SW with relay 3302 appearing in FIG. 3B.

Referring to FIG. 4, the main SW with relay 3302 has an internal relay 4001, and in response to an on-interrupt signal, the internal relay 4001 is turned on. On this occasion, a main SW lever 4004 is tilted on an Off side, but when the internal relay 4001 is turned on, the main SW lever 4004 is tilted on an ON side, so that DC power is supplied to the main power supply unit 3400. When the DC power is supplied to the main power supply unit 3400, the input-output control unit (IO Cont) 3401 appearing in FIG. 3B carries out the next process.

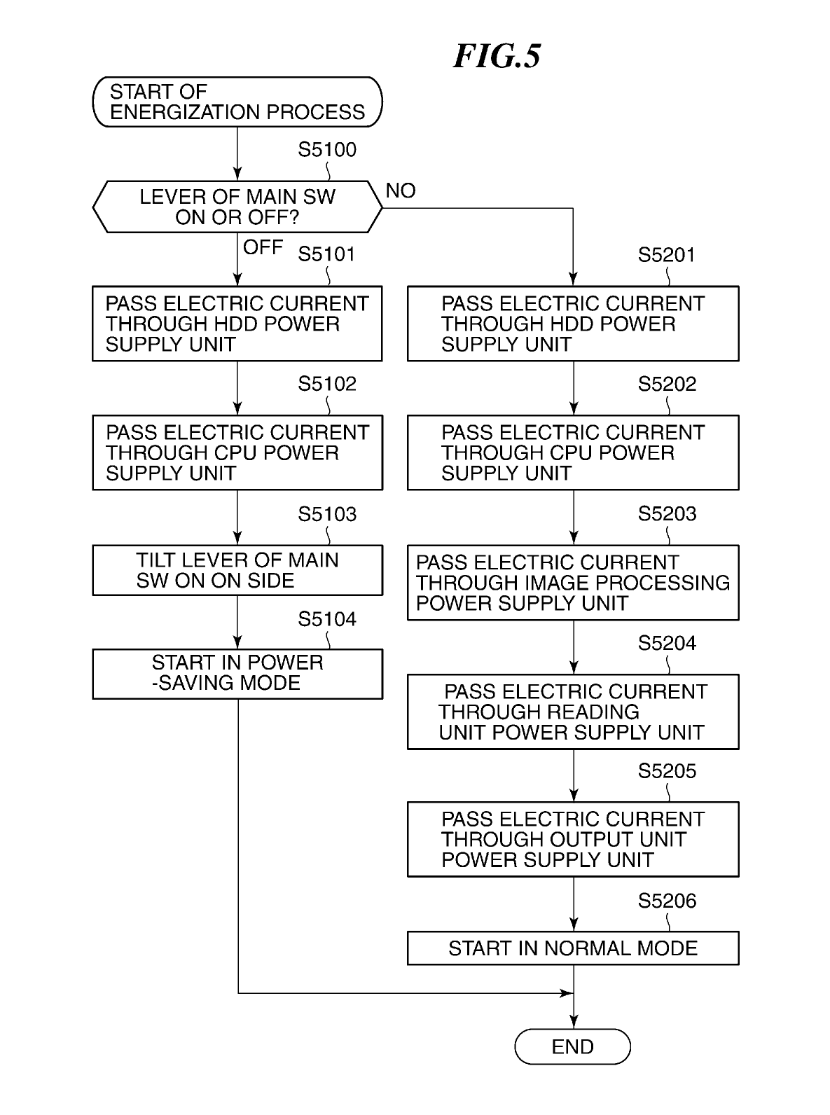

FIG. 5 is a flowchart useful in explaining a process carried out by the input-output control unit 3401 when power is supplied to the main power supply unit 3400 appearing in FIG. 3B.

Referring to FIGS. 3A to 5, the main SW with relay 3302 is provided with a position sensor 4002, which detects the position of the main SW lever 4004. The position sensor 4002 sends a lever position sensor signal to the IO Cont 3401, and in response to the lever position sensor signal, the IO Cont 3401 checks whether the main SW lever 4004 is tilted on the ON side or the OFF side (step S5100).

When the main SW lever 4004 is tilted on the OFF side (OFF in the step S5100), the IO Cont 3401 controls the SW so that DC power can be supplied from the AC/DC converter 3202 to the HDD power supply unit 3500 (step S5101). Further, the IO Cont 3401 controls the SW so that DC power can be supplied from the AC/DC converter 3202 to the CPU power supply unit 3600 (step S5102).

After that, the IO Cont 3401 sends out a lever tilt signal to the main SW with relay 3302. The lever tilt signal is supplied to a solenoid 4003 provided in the main SW with relay 3302, and in response to this, the solenoid 4003 tilts the main SW lever 4004 on the ON side (step S5103). As a result, the state in which power in the multifunctional peripheral 1100 is on and the state in which the main SW with relay 3302 is on match each other.

After that, power is supplied to both of the two lines in the NIC unit 3301, which in turn comes to be able to carry out processing on, for example, a proxy response packet or an ordinary network packet. Then, the multifunctional peripheral 1100 enters a so-called sleep mode (power-saving mode: step S5104), and the process by the IO Cont 3401 is brought to an end.

As described above, upon receiving an on-command from the host computer 1600, the multifunctional peripheral 1100 turns on power to the main power supply unit 3400, the HDD power supply unit 3500, and the CPU power supply unit 3600. DC power is not supplied to the image processing power supply unit 3700, the reading unit power supply unit 3800, and the output unit power supply unit 3900 appearing in FIG. 3A.

Thus, because no power is supplied to the fixing unit 3902 and the exposure unit 3905 which consume a large amount of power, power consumption at the time of activation can be reduced. In this state, the multifunctional peripheral 1100 lies in the sleep mode. In the sleep mode, for example, the NIC unit 3301 is able to receive a print instruction command from a network, and receive a button interrupt signal from the wake button 3403.

Upon receiving a print instruction command from a network, the NIC unit 3301 transfers a print instruction command to the IO Cont 3401. Further, the IO Cont 3401 controls the SW so that power can be supplied to the image processing power supply unit 3700 and the output unit power supply unit 3900 which are required for printing. This enables printing processing.

On the other hand, when a user (also referred to as an operator) depresses the wake button 3403, the IO Cont 3401 detects a button interrupt signal from the wake button 3403. Then, the IO Cont 3401 controls the SW so that power can be supplied to the image processing power supply unit 3700, the reading unit power supply unit 3800, and the output unit power supply unit 3900, and the multifunctional peripheral 1100 can be brought into a standby state from the sleep state.

Power to the multifunctional peripheral 1100 may be turned on not only in response to an on remote command, but also by the user tilting (manually operating) the main SW lever 4004 of the main SW with relay 3302 on the ON side. When the user tilts the main SW lever 4004 on the ON side, power is supplied to the main power supply unit 3400 to supply the IO Cont 3401 with power.

As described above, in the step S5100 in FIG. 5, the IO Cont 3401 checks the position sensor 4002 to determine whether or not the main SW lever 4004 is tilted on the ON side. When the main SW lever 4004 is tilted on the ON side (ON in the step S5100), first, the IO Cont 3401 controls the SW to supply power to the HDD power supply unit 3500 (step S5201). Then, the IO Cont 3401 supplies power to the CPU power supply unit 3600 (step S5202), and further supplies power to the image processing power supply unit 3700 (step S5203). Then, the IO Cont 3401 supplies power to the reading unit power supply unit 3800 (step S5204), and further supplies power to the output unit power supply unit 3900, followed by terminating the power supply process.

As described above, when the main SW with relay 3302 is manually turned on, the IO Cont 3401 starts the multifunctional peripheral 1100 according to a starting procedure (starting mode) set in advance. Namely, when the main SW lever 4004 is tilted on the ON side by the user, the multifunctional peripheral 1100 is started in the starting mode as in the case of main power-on, and goes into the standby state.

It should be noted that power to the standing power supply unit 3300 should not necessarily be supplied from the AC/DC converter 3201, but power may be supplied to the standing power supply unit 3300 from a battery. By using a battery like this, power consumption of the AC power source can be zero when the main power supply unit 3400 is not on.

As described above, although in the multifunctional peripheral 1100, upon receiving an on-command, the IO Cont 3401 supplies power to the HDD power supply unit 3500 and the CPU power supply unit 3600, a power supply unit that is supplied with power may be added as described below.

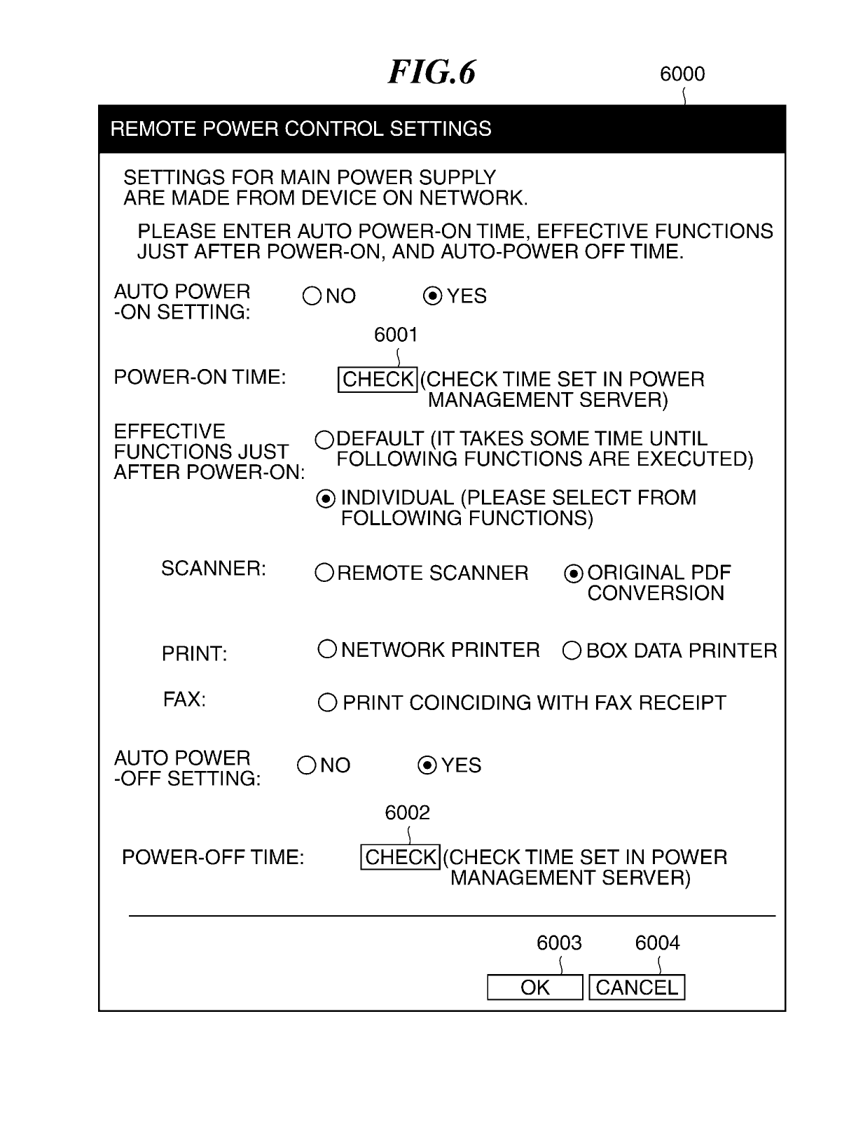

FIG. 6 is a diagram showing an exemplary remote power control setting screen (local screen) displayed when a power supply unit that is supplied with power is added or changed in the multifunctional peripheral 1100 appearing in FIGS. 3A and 3B.

Now, when the user adds or changes a power supply unit, which is supplied with power, thorough an operation unit (not shown), the CPU 3601 appearing in FIG. 3A displays a remote power control setting screen (hereafter also referred to as a local screen) 6000 appearing in FIG. 6 on a display unit (not shown). Referring to FIG. 6, on the local screen 6000, there are an “Auto power-on setting”, an “Effective function setting just after power-on”, and an “Auto power-off setting”. The effective function setting just after power-on includes default and individual, and further, individual includes scanner, print, and FAX.

In the example shown in FIG. 6, on the local screen 6000, the auto power-on setting is configured at “Yes”, and the effective function setting just after power-on is set at “Individual”. Also, “Original PDF conversion” is individually set. Further, the auto power-off setting is configured at “Yes” here.

When the auto power-on setting is configured at “No” on the local screen 6000, the CPU 3601 changes values in an internal register of the NIC unit 3301 via the IO Cont 3401. As a result, the NIC unit 3301 outputs no interrupt signal even when receiving an on-command.

Because the NIC unit 3301 outputs no interrupt signal even when receiving an on-command, no power is supplied to the main power supply unit 3400, and as a result, power to the multifunctional peripheral 1100 is kept off.

On the other hand, when the auto power-on setting is configured at “YES”, the CPU 3601 enables checking of on-time and selection of the effective function setting just after power-on. When an on-time checking button 6001 is depressed, the CPU 3601 queries the host computer 1600 (here, also referred to as the power management server) as to a power-on time (power supply time) set in the host computer 1600. Then, the CPU 3601 displays the power-on time obtained as a result of the query on the local screen 6000.

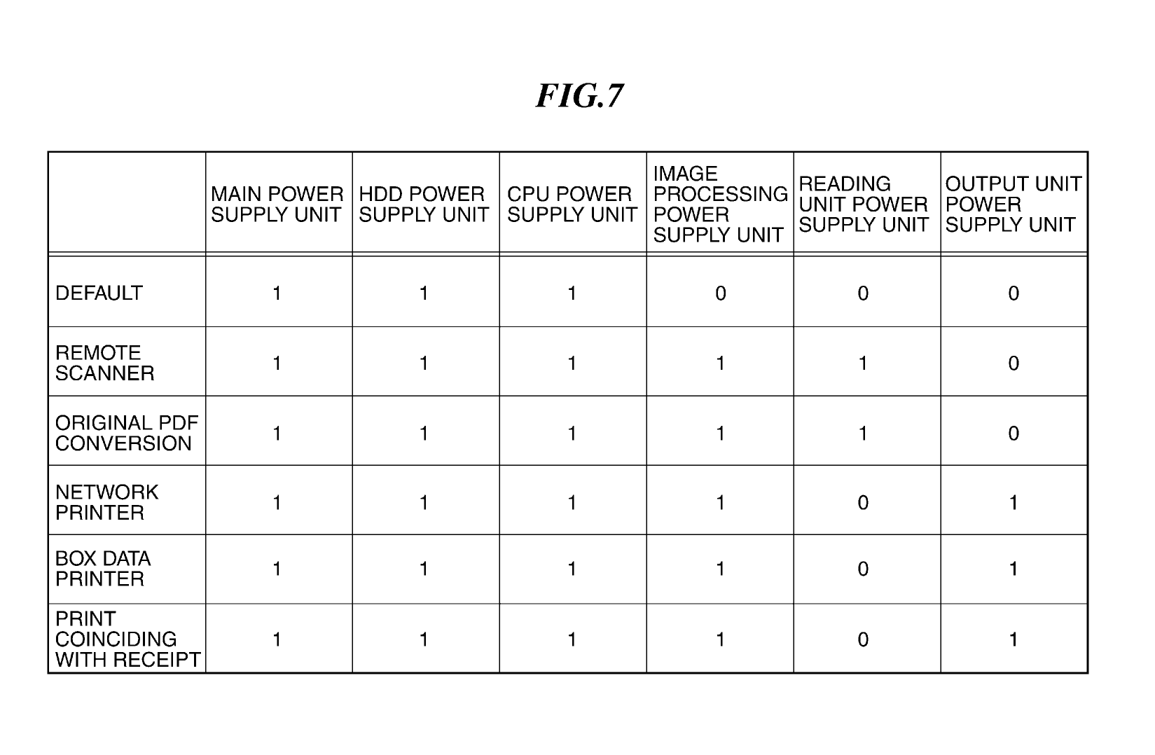

FIG. 7 is a diagram showing power control settings according to functions selected in the effective function setting right after power-on appearing in FIG. 6.

Referring to FIG. 7, according to a function selected in the effective function setting right after power-on (effective function or effective functional unit) appearing in FIG. 6, the CPU 3601 changes a power control setting value and sets the power control setting value in an internal register (power control output port register: not shown) of the IO Cont 3401.

In FIG. 7, there are “Default”, “Remote scanner”, “Original PDF conversion”, “Network printer”, “BOX data printer”, and “Print coinciding with FAX receipt” as functions. Correspondingly to these functions, setting as to turning on/off of “Main power supply unit”, “HDD power supply unit”, “CPU power supply unit”, “Image processing power supply unit”, “Reading unit power supply unit”, and “Output unit power supply unit” (that is, power control setting values) are defined.

It should be noted that “1” represents ON, and “0” represents OFF. Normal settings mean “Default”, and in “Default”, when power-on instruction is received, power is supplied to the main supply unit 3400, the HDD power supply unit 3500, and the CPU power supply unit 3600.

When “Default” is selected in the effective function setting right after power-on, the CPU 3601 sets “111000” in the power control output port register of the IO Cont 3401. Therefore, in response to the NIC unit 3301 receiving an on-command, the IO Cont 3401 turns on the HDD power supply unit 3500 and the CPU power supply unit 3600 as described above.

On the other hand, when “Original PDF conversion” is selected in “Individual” as shown in FIG. 6, the CPU 3601 sets “111110” in the power control output port register of the IO Cont 3401 as shown in FIG. 7 (namely, power control setting values are determined). Therefore, in response to the NIC unit 3301 receiving an on-command, the IO Cont 3401 supplies power to the HDD power supply unit 3500, the CPU power supply unit 3600, the image processing power supply unit 3700, and the reading unit power supply unit 3800.

It should be noted that when a plurality of functions are selected in “Individual”, the CPU 3601 sets a logical sum of functions shown in FIG. 7 in the power control output port register of the IO Cont 3401.

For example, when “Original PDF conversion” and “Network printer” are selected in “Individual”, the CPU 3601 sets a logical sum “11111” of “111110” which is a power control setting value for original PDF conversion and “111101” which is a power control setting value for network printers in the power control output port register of the IO Cont 3401. As a result, in response to the NIC unit 3301 receiving an on-command, the IO Cont 3401 supplies power to the HDD power supply unit 3500, the CPU power supply unit 3600, the image processing power supply unit 3700, the reading unit power supply unit 3800, and the output power supply unit 3900.

When the automatic power-off setting is configured at “No” on the local screen 6000 shown in FIG. 6, the CPU 3601 changes values in the internal register of the NIC unit 3301 via the IO Cont 3401. As a result, even when receiving an off-command, the NIC unit 3301 does not transfer the off-command to the IO Cont 3401.

On the other hand, when the automatic power-off setting is configured at “Yes” on the local screen 6000 shown in FIG. 6, the CPU 3601 enables checking of off-time. When an off-time checking button 6002 is depressed, the CPU 3601 queries the host computer 1600 as to a power-off time set in the host computer 1600. Then, the CPU 3601 displays the power-off time obtained as a result of the query on the local screen 6000.

Upon receiving an off-command in a case where the power-off setting is configured at “Yes“, the NIC unit 3301 transfers the off-command to the IO Cont 3401. As a result, the IO Cont 3401 notifies the CPU 3601 of a power-off processing request.

Upon receiving the power-off processing request, the CPU 3601 saves an active job to the HDD 3501 as described above. Then, after confirming that data saving has been completed, the CPU 3601 sends a power-off request to the IO Cont 3401. In response to the power-off request, the IO Cont 3401 turns off the relay 4001 and the solenoid 4003 of the main SW with relay 3302.

When the relay 4001 and the solenoid 4003 are turned off, the main SW lever 4004 is tilted on the OFF side. The position sensor 4002 detects this, and the IO Cont 3401 turns off power supply to the main power supply unit 3400, the HDD power supply unit 3500, the CPU power supply unit 3600, the image processing power supply unit 3700, the reading unit power supply unit 3800, and the output power supply unit 3900.

When an OK button 6003 is depressed after “the automatic power-on setting”, “the effective function setting right after power-on”, and “the automatic power-off setting” are configured on the local screen 6000, “the automatic power-on setting”, “the effective function setting right after power-on”, and “the automatic power-off setting” configured on the local screen 6000 are set in the multifunctional peripheral 1100. When a cancel button 6004 is depressed, the above settings are canceled.

It should be noted that instead of controlling power supply units, which supply power, in the above described manner, the fixing unit 3902 may be selectively powered on and off. For example, when the main SW lever 4004 is tilted on the ON side so as to start power supply, power of 1500 W may be supplied to the fixing unit 3902. On the other hand, when power supply is to be started through remote power control, power of 700 W may be supplied to the fixing unit 3902. As a result, power supplied to the fixing unit 3902 can be reduced, which controls inrush current and prevents turning-off of a power-supply breaker.

As described above, according to the present embodiment, in a case where a plurality of multifunctional peripherals are connected to a network, when a power-on instruction from a host computer is received via the network, power is supplied only to the HDD power supply unit and the CPU power supply unit (the functional units designated in advance) to start the multifunctional peripherals in a power-saving mode.

Therefore, inrush current at the start of the multifunctional peripherals is decreased, and hence power consumption is reduced, which prevents turning-off of the breaker. Further, because the host computer issues the power-on instruction to the multifunctional peripherals in unison, the start-up time can be reduced with respect to all the multifunctional peripherals. As a result, even if the number of multifunctional peripherals increases, the time required for start-up never increases. In addition, even if a multifunctional peripheral that cannot be powered on due to a failure lies on the network, all multifunctional peripherals except the faulty multifunctional peripheral can be started.

As is clear from the above description, in FIGS. 3A and 3B, the NIC unit 3301 acts as a receiving unit. The IO Cont 3401, the main SW with relay 3302, the AC/DC converter 3202, and the SWs 3202a to 3202e act as a first power control unit and a second power control unit. The NIC unit 3301 and the main SW with relay 3302 act as a third power control unit. Further, the CPU 3601, the IO Cont 3401, and the NIC unit 3301 act as a first setting unit, and the CPU 3601 and the IO Cont 3401 act as a second setting unit. The AC/DC converters 3201 and 3202 act as a power generation unit that generates power which is to be supplied to a plurality of functional units which the information processing apparatus has.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-221786 filed Sep. 30, 2010, which is hereby incorporated by reference herein in its entirety.

What is claimed is:

1. An information processing apparatus capable of communicating with a power monitoring apparatus via a network, comprising:
a power generation unit configured to generate power that should be supplied to a plurality of functional units which the information processing apparatus has;
a main power supply switch configured to be manually operated;
a receiving unit configured to receive a power-on instruction from the power monitoring apparatus via the network;
a first power control unit configured to, in response to said main power switch being manually operated by an operator of the information processing apparatus in a state where the power generated by said power generation unit is not supplied to the plurality of functional units, provide control to supply the power generated by said power generation unit to the plurality of functional units; and
a second power control unit configured to, in response to said receiving unit receiving the power-on instruction from the power monitoring apparatus via the network in a state where the power generated by said power generation unit is not supplied to the plurality of functional units, provide control to supply the power generated by said power generation unit to functional units designated in advance among the plurality of functional units.

2. An information processing apparatus according to claim 1, one of the plurality of functional units comprises a first functional unit to which power is supplied irrespective of whether said main power switch is operated and a third power control unit that supplies power to said second power control unit in response to said receiving unit receiving the power-on instruction from the power monitoring apparatus.

3. An information processing apparatus according to claim 1, the functional units designated in advance are functional units that consume a smaller amount of power as compared to the other functional units.

4. An information processing apparatus according to claim 1, wherein
the power monitoring apparatus issues the power-on instruction at a power-on time at which power is supplied to the information processing apparatus, and issues a power-off instruction at a power-off time at which power to the information processing apparatus is turned off, and in response to said receiving unit receiving the power-off instruction from the power monitoring apparatus, said second power control unit turns off the information processing apparatus.

5. An information processing apparatus according to claim 4, further comprising a first setting unit configured to set at least one of the power-on time and the power-off time for the power monitoring apparatus.

6. An information processing apparatus according to claim 1, further comprising a second setting unit configured to set, as an effective functional unit, a functional unit that is to be enabled among the plurality of functional units when the power-on instruction is received,
wherein according to the effective functional unit set by said second setting unit, said second power control unit determines the functional units designated in advance to which power is supplied.

7. A power control method for remotely controlling power to an information processing apparatus having a plurality of functional units to which power is supplied independently of each other, and a main power switch that is manually operated, and capable of communicating with a power monitoring apparatus via a network, comprising:
a power generation step of generating power that should be supplied to the plurality of functional units which the information processing apparatus has;
a receiving step of receiving a power-on instruction from the power monitoring apparatus via the network;
a first power control step of, in response to the main power switch being manually operated by an operator of the information processing apparatus in a state where the power generated in said power generation step is not supplied to the plurality of functional units, providing control to supply the power generated in said power generation step to the plurality of functional units; and
a second power control step of, in response to receipt of the power-on instruction from the power monitoring apparatus via the network in said receiving step in a state where the power generated in said power generation step is not supplied to the plurality of functional units, providing control to supply the power generated in said power generation step to functional units designated in advance among the plurality of functional units.

8. A computer-readable non-transitory storage medium storing a power control program that implements a power control method for remotely controlling power to an information processing apparatus having a plurality of functional units to which power is supplied independently of each other, and a main power switch that is manually operated, and capable of communicating with a power monitoring apparatus via a network, the method comprising:
a power generation step of generating power that should be supplied to the plurality of functional units which the information processing apparatus has;
a receiving step of receiving a power-on instruction from the power monitoring apparatus via the network;
a first power control step of, in response to the main power switch being manually operated by an operator of the information processing apparatus in a state where the power generated in the power generation step is not supplied to the plurality of functional units, providing control to supply the power generated in the power generation step to the plurality of functional units; and
a second power control step of, in response to receipt of the power-on instruction from the power monitoring apparatus via the network in said receiving step in a state where the power generated in the power generation step is not supplied to the plurality of functional units, providing control to supply the power generated in the power generation step to functional units designated in advance among the plurality of functional units.
